(19) United States
(12) Patent Application Publication
(10) Pub. No.: US 2019/0070066 A1
(43) Pub. Date: Mar. 7, 2019

(54) SIMULTANEOUS COMPRESSION, TENSION, AND MOVEMENT THERAPY DEVICE

(71) Applicant: Kyle Bowling, Louisville, KY (US)

(72) Inventor: Kyle Bowling, Louisville, KY (US)

(21) Appl. No.: 15/977,683

(22) Filed: May 11, 2018

Related U.S. Application Data
(60) Provisional application No. 62/554,720, filed on Sep. 6, 2017.

(51) Int. Cl. A61H 15/00

(52) U.S. Cl. CPC A61H 15/0092; A61H 2015/0042; A61H 39/04; A61H 2201/1685; A61H 2201/1284; A61H 2015/0035

(57) ABSTRACT

The present invention is directed to a physical therapy device for providing simultaneous compression, tension, and movement treatment in myofascial release therapy. Such a device may provide general compression force and trigger point compression force while simultaneously providing a user with muscle tension and resistance in movement exercises. Such a device may preferably comprise a flexible and resilient band component incorporating a plurality of hemispherical components to achieve such a function. Such a flexible and resilient band may vary in length, width, and thickness as appropriate, and such hemispherical components may vary in size, hardness, and quantity as appropriate.

### PRIORITY NOTICE

The present application is a non-provisional utility application and makes a claim of priority under 35 U.S.C. § 119(e) to prior provisional application 62/554,720 filed in the U.S. Patent and Trademark Office on Sep. 6, 2017.

### TECHNICAL FIELD OF THE INVENTION

The present invention relates in general to physical therapy devices, and more specifically to a simultaneous compression, tension, and movement device for use in myofascial release therapy. Such a device should provide general compression force and trigger point compression force while simultaneously providing a user with muscle tension and resistance in movement exercises. Such a device may preferably comprise a flexible and resilient band component incorporating a plurality of hemispherical components to achieve such a function.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Myofascial release therapy is a medical therapy used in the treatment of skeletal muscle immobility, the aim of which is to reduce pain by relaxing contracted muscles, improving blood flow and lymphatic circulation to those muscles, and stimulating the stretch reflex of the affected muscles. Such therapy has classically involved manual manipulation or, more recently, device-assisted compression of the affected muscle groups to promote the intended treatment. Such compression may be effected via general compression force, for broad treatment of larger muscle groups, or may be effected via trigger point compression, for more focused treatment of specifically identified pathological sites. Various devices exist to aid in such treatment, though such designs do not allow for compression treatment of the affected muscle group while simultaneously providing muscle tension and resistance in movement exercises.

It is known to have a cylindrical device that may comprise a rigid, semi-rigid, or hollow core wrapped in an outer layer. The outer layer of such a device may vary in softness and compression characteristics to provide a desired resistance to a user of such a device. Such an outer layer may comprise any of a series of materials including, for example, leathers, plastics, or foams. Such a design can facilitate the general compression of certain muscle groups during conventional myofascial release treatment, though does not allow for simultaneous tension release and movement therapy since the user must use their own body weight as a source of compression force. Also, such a design does not permit attachment to the body of a user because of limitations inherent in the design. Such devices are commonly termed “Foam Rollers” or “Homemade Rollers.”

It is known to have a cylindrical device similar to that described above which further comprises a textured or bumpy surface. Such a textured or bumpy surface may similarly comprise any of a series of materials including, for example, leathers, plastics, or foams, and may also vary in softness and compression characteristics to provide a desired resistance to a user of such a device. Such a design can facilitate the application of trigger point compression force, though otherwise comprises the same limitations as those of the smooth foam roller. Such devices are commonly termed “TriggerPoint GRID Rollers” or “Rumble Rollers.”

It is known to have a cylindrical device that may comprise a central roller body and a plurality of fixed lateral hand grips. It is further known to have a cylindrical device that may comprise a fixed central hand grip and a plurality of lateral roller bodies. Such designs may permit the application of general compression force or trigger point compression force based on variances in their designs, and may permit the application of greater or more controlled compression force as a result of their comprising said hand grips. Such designs, though, otherwise comprise the same limitations as the various rollers noted above as they do not permit attachment to the body of a user and require the self-application of compression force by the user. Such devices are commonly termed “Massage Roller Sticks” or “Quad Rollers.”

It is known to have a spherical device that may comprise a rigid, semi-rigid, or hollow core wrapped in an outer layer. The outer layer of such a device may vary in softness and compression characteristics to provide a desired resistance to a user of such a device. Such an outer layer may comprise any of a series of materials including, for example, leathers, plastics, or foams. Such a design can facilitate the trigger point compression of certain muscle groups during conventional myofascial release treatment, though does not allow for simultaneous tension release and movement therapy since the user must apply their own compression force during treatment. Such devices are commonly termed “Trigger Point Balls,” “Mobility Balls,” or “Massage Balls.” As an alternative, a user may simply use a lacrosse ball, softball, medicine ball, or other appropriate spheroid to achieve a similar result.

It is known to have a band device that may comprise a linear strip of flexible material. Such a device may comprise any of a series of materials including, for example, rubber, plastic, vinyl, or cloth, and may vary in length, thickness, and elasticity. Such a linear device may be applied to a user by wrapping said device around a muscle group to be treated, and can facilitate the general compression of certain muscle groups during conventional myofascial release treatment. Such a design, though, does not allow for the application of trigger point compression force. Such devices are commonly termed “Floss Mobility Bands” or “Muscle Compression Bands.”

It is known to have a band device that may comprise a continuous loop of flexible material. Such a device may comprise any of a series of materials including, for example, plastic, vinyl, or cloth, and may vary in length, thickness, and elasticity. Such a continuous loop material may be applied to a user by placing, for example, two points on the user's body into the loop and extending one such point away from the other. Such designs can facilitate the general treatment of certain muscle groups between said points on a user's body during conventional myofascial release treatment, though does not allow for simultaneous tension release and movement therapy since the user must use their own body strength as a source of compression force. Such devices are commonly termed “Resistance Loops” or “Exercise Bands.”

There is a need in the art for a simultaneous compression, tension, and movement device for use in myofascial release therapy. Such a device should provide general compression force and trigger point compression force while simultaneously providing a user with muscle tension and resistance in movement exercises. Such a device may preferably comprise a flexible and resilient band component incorporating a plurality of hemispherical components to achieve such a function.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a simultaneous compression, tension, and movement device for use in myofascial release therapy.

It is an objective of the present invention to provide a simultaneous compression, tension, and movement device for use in myofascial release therapy comprising, at least, a flexible and resilient band component and a plurality of hemispherical components. Such flexible and resilient band may vary in length, width, and/or thickness so as to provide varying general compression characteristics to a user. Such hemispherical components may be removably attached to said band component, or may be permanently affixed to said band component. Such hemispherical components may also vary in size so as to provide varying trigger point compression characteristics to a user.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 shows an overall view of Embodiment 1 001 of the present invention noting a flexible band 100, having a first end 110 and a second end 120. The figure also shows a plurality of hemispherical components 200 attached to said first end 110 of flexible band 100.

FIG. 2 shows a top view of Embodiment 1 001 of the present invention noting a flexible band 100 having a first end 110. The figure also shows a plurality of hemispherical components 200 attached to the flexible band 100.

FIG. 3 shows a bottom view of Embodiment 1 001 of the present invention noting a flexible band 100 having a first end 110. The figure shows a plurality of bolts 400 and a plurality of washers 500 which may be used to secure said hemispherical components 200 to said first end 110 of said flexible band 100.

FIG. 4 shows a front view of Embodiment 1 001 of the present invention noting a flexible band 100, a plurality of hemispherical components 200, a plurality of bolts 400, a plurality of washers 500, and a bolt receiver 600.

FIG. 5 shows a rear view of Embodiment 1 001 of the present invention noting a flexible band 100, a plurality of bolts 400, and a plurality of washers 500.

FIG. 6 shows a right side view of Embodiment 1 001 of the present invention noting a flexible band 100, having a first end 110 and a second end 120, and a plurality of hemispherical components 200 attached to said first end 110 of flexible band 100.

FIG. 7 shows a left side view of Embodiment 1 001 of the present invention noting a flexible band 100, having a first end 110 and a second end 120, and a plurality of hemispherical components 200 attached to said first end 110 of flexible band 100.

FIG. 8 shows an overall view of Embodiment 1 001 of the present invention noting a flexible band 100. The figure also shows a plurality of hemispherical components 200, a plurality of bolts 400, and a plurality of washers 500.

FIG. 9 shows an overall view of a plurality of hemispherical components 200. Said hemispherical component 200 further comprises a flat surface 220. The figure shows a bolt receiver 600 attached to said flat surface 220 of hemispherical component 200. Also shown is the relative attachment of a bolt 400 and a washer 500 to a bolt receiver 600 attached to said flat surface 220 of hemispherical component 200.

FIG. 10 shows an overall view of a plurality of hemispherical components 200. Said hemispherical component 200 further comprises a flat surface 220. The figure shows a bolt receiver 600 attached to said flat surface 220 of hemispherical component 200. Also shown is the relative attachment of a bolt 400 and a washer 500 to a bolt receiver 600 attached to said flat surface 220 of hemispherical component 200.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The various embodiments of the invention have advantageous features not present in conventional myofascial release therapy devices. The simultaneous compression, tension, and movement device for use in myofascial release therapy disclosed herein can provide an individual with a means for applying general compression force and trigger point compression force while simultaneously providing a user with muscle tension and resistance in movement exercises. Additionally, the device may comprise a flexible and resilient band component and a plurality of hemispherical components. Such flexible and resilient band may vary in length, width, and/or thickness so as to provide varying general compression characteristics to a user. Such hemispherical components may be removably attached to said band component, or may be permanently affixed to said band component. Such hemispherical components may also vary in size so as to provide varying trigger point compression characteristics to a user.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

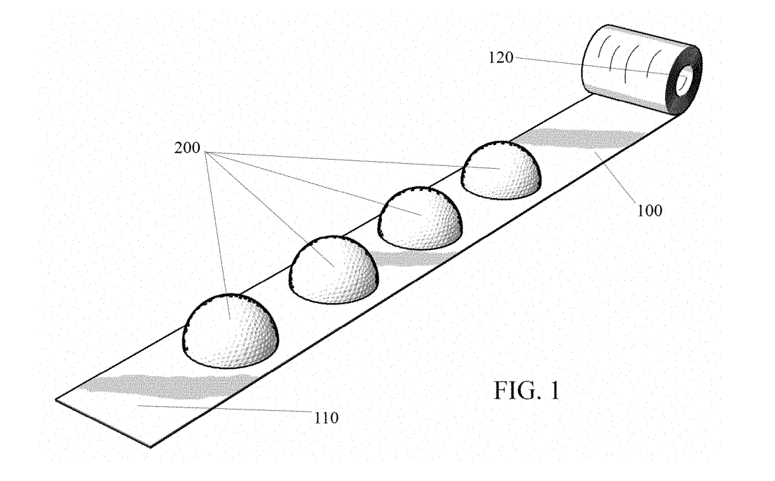

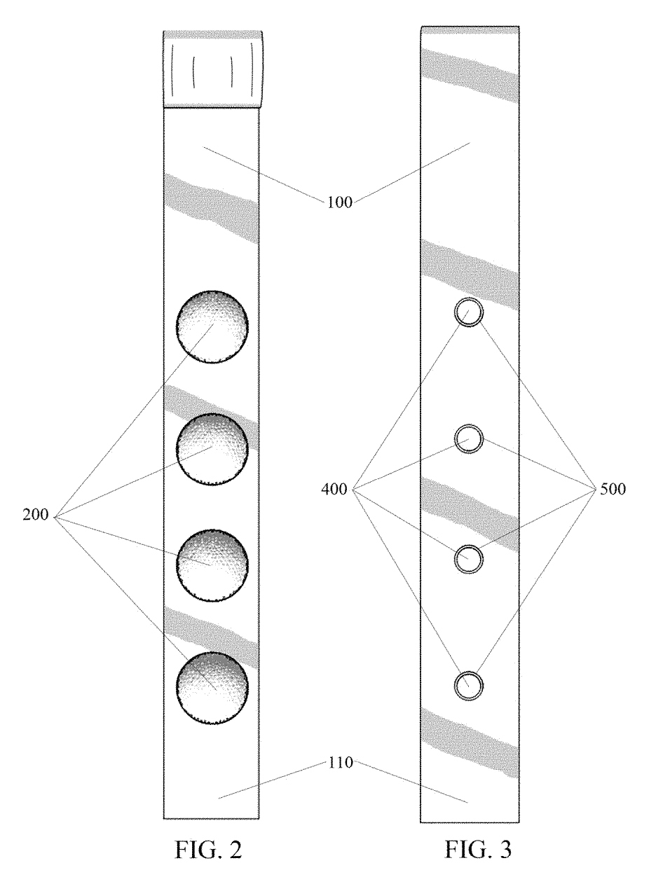

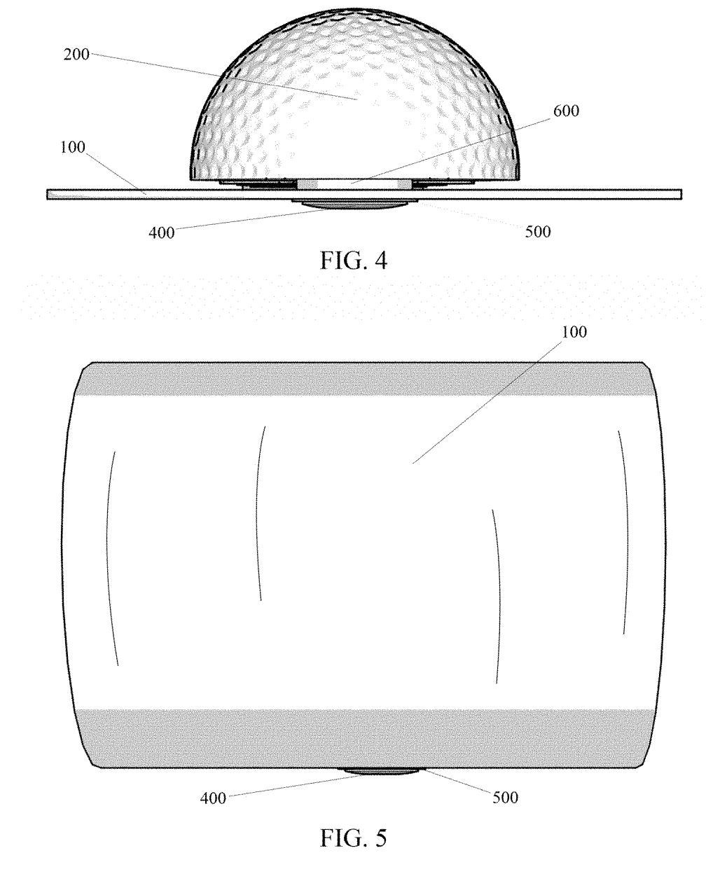

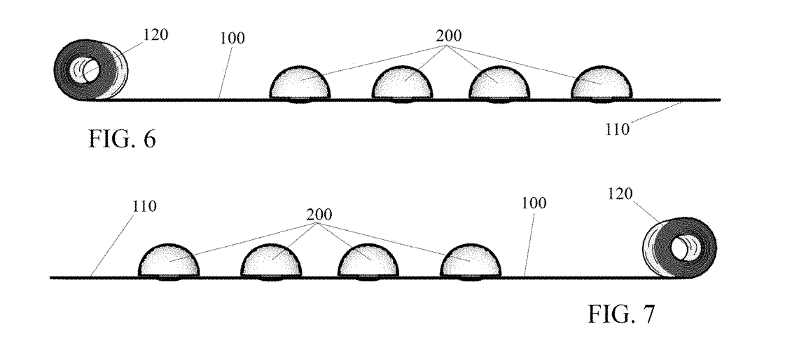

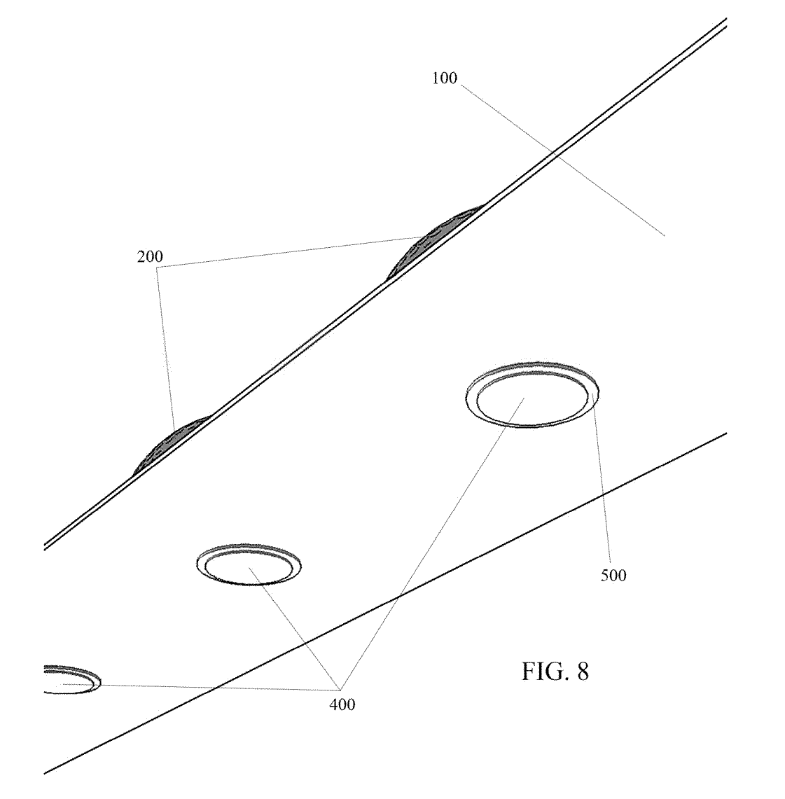

In FIG. 1 a simultaneous compression, tension, and movement device for use in myofascial release therapy comprising, at least, a flexible and resilient band component and a plurality of hemispherical components is illustrated, in accordance with an Embodiment 1 001 of the present invention. The figure illustrates a flexible band 100, having a first end 110 and a second end 120. The figure also shows a plurality of hemispherical components 200 attached to said first end 110 of flexible band 100. FIG. 2 shows a top view of Embodiment 1 001 of the present invention noting a flexible band 100 having a first end 110. The figure also shows a plurality of hemispherical components 200 attached to the flexible band 100. FIG. 3 shows a bottom view of Embodiment 1 001 of the present invention noting a flexible band 100 having a first end 110. The figure shows a plurality of bolts 400 and a plurality of washers 500 which may be used to secure said hemispherical components 200 to said first end 110 of said flexible band 100. FIG. 4 shows a front view of Embodiment 1 001 of the present invention noting a flexible band 100, a plurality of hemispherical components 200, a plurality of bolts 400, a plurality of washers 500, and a bolt receiver 600. FIG. 5 shows a rear view of Embodiment 1 001 of the present invention noting a flexible band 100, a plurality of bolts 400, and a plurality of washers 500. FIG. 6 shows a right side view of Embodiment 1 001 of the present invention noting a flexible band 100, having a first end 110 and a second end 120, and a plurality of hemispherical components 200 attached to said first end 110 of flexible band 100. FIG. 7 shows a left side view of Embodiment 1 001 of the present invention noting a flexible band 100, having a first end 110 and a second end 120, and a plurality of hemispherical components 200 attached to said first end 110 of flexible band 100. FIG. 8 shows an overall view of Embodiment 1 001 of the present invention noting a flexible band 100. The figure also shows a plurality of hemispherical components 200, a plurality of bolts 400, and a plurality of washers 500.

By reference to the illustrations in FIGS. 1 through 8, the device disclosed herein may be applied to a user by first placing said plurality of hemispherical components 200 against the muscle group to which trigger point compression is to be applied. While holding the hemispherical components 200 in place, a user may then wrap said flexible band 100 around the applicable muscle group or body component beginning from said first end 110 and extending out to said second end 120. A distal edge of said second end 120 of said flexible band 100 may be tucked into the resulting structure created by the process of wrapping said flexible band 100 around said applicable muscle group or body component. Such resulting structure may effect the application of general compression force to said applicable muscle group, while simultaneously providing a user with muscle tension and resistance in movement exercises

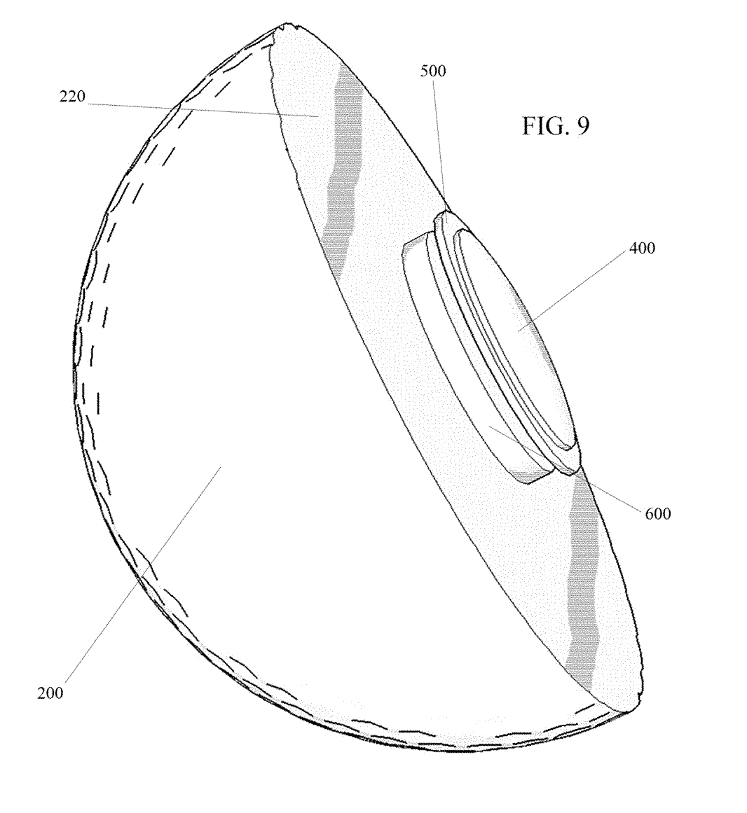

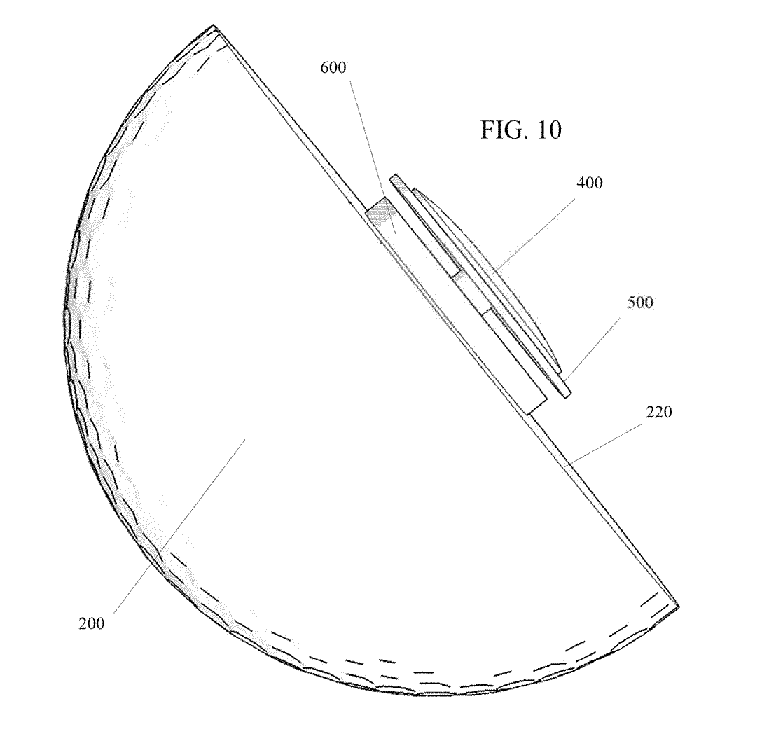

FIG. 9 shows an overall view of a plurality of hemispherical components 200. Said hemispherical component 200 further comprises a flat surface 220. The figure shows a bolt receiver 600 attached to said flat surface 220 of hemispherical component 200. Also shown is the relative attachment of a bolt 400 and a washer 500 to a bolt receiver 600 attached to said flat surface 220 of hemispherical component 200. FIG. 10 shows an overall view of a plurality of hemispherical components 200. Said hemispherical component 200 further comprises a flat surface 220. The figure shows a bolt receiver 600 attached to said flat surface 220 of hemispherical component 200. Also shown is the relative attachment of a bolt 400 and a washer 500 to a bolt receiver 600 attached to said flat surface 220 of hemispherical component 200.

By reference to the illustrations in FIGS. 9 and 10, a bolt 400 may be inserted into a washer 500 to form a bolt-washer component. Said bolt-washer component may then be inserted into a bolt receiver 600 which may be permanently affixed to a flat surface 220 of a hemispherical component 200. Such a combination may provide for permanent or removable attachment of a hemispherical component 200 to a first end 110 of a flexible band 100.

A hemispherical component 200 may vary in size, hardness, and quantity to suit various applications. By way of example, a hemispherical component 200 may range in size from that equivalent to a small bump or knot to that equivalent to a tennis ball, though is shown in Embodiment 1 001 of the present invention as being the size of a golf ball. By way of example, a hemispherical component 200 may range in hardness from that equivalent to a foam ball to that equivalent to a marble, though is shown in Embodiment 1 001 of the present invention as being the hardness of a golf ball. By way of example, a hemispherical component 200 may range in quantity from one to any appropriate number more than one, though is shown in Embodiment 1 001 of the present invention as having a quantity of four. It is considered advantageous to the present invention to note that larger quantities of hemispherical components 200 may be inversely proportional with smaller sizes of hemispherical components 200, thus suggesting a myofascial release therapy device as described herein may comprise a large number of small hemispherical components 200 or a small number of larger hemispherical components 200.

A hemispherical component 200 may be substantially constructed of any suitable material or combination of materials, but typically is constructed of a resilient material or combination of materials such that the combination is resistant to wear and damage as a result of everyday use. As an example, and without limiting the scope of the present invention, various exemplary embodiments of a simultaneous compression, tension, and movement device for use in myofascial release therapy may be substantially constructed of one or more materials of elastane, rubber, latex, leather, denim, cotton, wool, nylon, polyester, silk, cashmere, acrylic, or combinations thereof. Additionally, one or more additional materials may be added to impart the desired amount of resiliency or elasticity, such as elastane, rubber, or latex.

A flexible band 100 may vary in length, width, and thickness to suit various applications. A flexible band 100 may vary in length from 1 foot long to 20 feet long, though is preferably 5 to 12 feet long. A flexible band 100 may vary in width from 1 inch wide to 24 inches wide, though is preferably 1 to 6 inches wide. A flexible band 100 may vary in thickness from 0.001 inch to 0.5 inch, though is preferably 0.025 to 0.075 inch thick.

A flexible band 100 may be substantially constructed of any suitable material or combination of materials, but typically is constructed of a resilient material or combination of materials such that the combination is resistant to wear and damage as a result of everyday use. As an example, and without limiting the scope of the present invention, various exemplary embodiments of a simultaneous compression, tension, and movement device for use in myofascial release therapy may be substantially constructed of one or more materials of elastane, rubber, latex, leather, denim, cotton, wool, nylon, polyester, silk, cashmere, acrylic, or combinations thereof. Additionally, one or more additional materials may be added to impart the desired amount of resiliency or elasticity, such as elastane, rubber, or latex.

Note with respect to the materials of construction, it is not desired nor intended to thereby unnecessarily limit the present invention by reason of such disclosure.

A simultaneous compression, tension, and movement device for use in myofascial release therapy comprising, at least, a flexible and resilient band component and a plurality of hemispherical components has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

I claim:

1. A simultaneous compression, tension, and movement device combination, comprising:
a flexible band having a first end and a second end;
a plurality of hemispherical components; and
a plurality of means for attachment;
wherein said hemispherical components are attached to said first end of said flexible band by said plurality of means for attachment.

2. The invention of claim 1,
wherein said flexible band comprises a resilient material.

3. The invention of claim 2,
wherein said plurality of hemispherical components further comprise a plurality of flat surfaces;
wherein said plurality of means for attachment comprise a plurality of bolts, a plurality of washers, and a plurality of bolt receivers.

4. The invention of claim 3,
wherein said plurality of bolt receivers are embedded into said plurality of flat surfaces of said plurality of hemispherical components; and
wherein said plurality of bolts are inserted through said plurality of washers, then through said first end of said flexible band, and then into said plurality of bolt receivers so as to attached said hemispherical components to said flexible band.

5. A method for simultaneous compression, tension, and movement therapy, comprising:
applying a plurality of hemispherical components to a muscle group of a user;
holding said plurality of hemispherical components against said muscle group of said user;
wrapping a flexible band around said muscle group of said user by beginning at a first end of said flexible band and extending out to a second end of said flexible band; and
performing a plurality of compression, tension, and movement therapy exercises.
